(19) United States
(12) Patent Application Publication
(10) Pub. No.: US 2010/0319416 A1
(43) Pub. Date: Dec. 23, 2010

(54) Water meter lock

(76) Inventor: Reynold R. Eller, JR., Ramsey, IL (US)

Correspondence Address: LITMAN LAW OFFICES, LTD., PATENT LAW BUILDING, 8955 CENTER STREET, MANASSAS, VA, 20110, US

(21) Appl. No.: 12/457,849

(22) Filed: Jun. 23, 2009

(51) Int. Cl. F16K 35/10

(52) U.S. Cl. 70/164; 70/180

(57) ABSTRACT

The water meter lock includes a hollow housing adapted to be placed over a valve and/or piping. The housing includes a closed side and an open side, the open side for insertion over the valve. A locking tab having a through bore extends laterally from adjacent the open side. Lateral sides of the valve include shaped cutouts or slots adapted to seat the housing on associated piping and/or accommodate extended portions of the valve. At least two of the lateral sides have aligned bores through which a locking pin is insertably mounted. The locking pin includes an enlarged head having a bore, which aligns with the bore of the locking tab. Once properly mounted and the bores aligned, a padlock locks the water meter lock.

### BACKGROUND OF THE INVENTION

1. Field of the Invention

The present invention relates to tamper prevention devices, and more particularly to a water meter lock that prevents unauthorized access to the water meter or valve.

2. Description of the Related Art

Public utilities such as water and sewage provide a much needed resource to the population at large. The costs for such provisions and upkeep are reflected in the water bill of a typical household. In order to reliably operate and maintain services, the commercial or governmental entity must rely on revenue from the public. If the household cannot meet the financial obligations, then they incur a loss of service, which usually results in shutting off the water supply by turning off the water meter. The same occurs when the domicile does not require service. However, the water meter is typically not secured in a manner that prevents an unscrupulous individual from turning the water back on. This unauthorized use results in loss of revenue and increased costs to the provider, which ultimately has a negative economic impact on the rest of the consumers.

Some solutions have been proposed in which a lockable cover is placed over a valve and locked by a padlock. However, these devices tend to be too specific with regard to the valve and not configured for wider application. Thus, it would be beneficial in the art to provide a locking device for a greater range of valves that will prevent unauthorized access and tampering of the same.

Thus, a water meter lock solving the aforementioned problems is desired.

### SUMMARY OF THE INVENTION

The water meter lock includes a hollow housing adapted to be placed over a valve and/or piping. The housing includes a closed side and an open side, the open side for insertion over the valve. A locking tab having a through bore extends laterally from adjacent the open side. Lateral sides of the valve include shaped cutouts or slots adapted to seat the housing on associated piping and/or accommodate extended portions of the valve. At least two of the lateral sides have aligned bores through which a locking pin is insertably mounted. The locking pin includes an enlarged head having through bore, which aligns with the bore of the locking tab. Once properly mounted and the bores aligned, a padlock locks the water meter lock.

These and other features of the present invention will become readily apparent upon further review of the following specification and drawings.

### BRIEF DESCRIPTION OF THE DRAWINGS

FIG. 1 is an environmental, perspective view of a water meter lock according to the present invention.

FIG. 2 is an exploded perspective view of the water meter lock according to the present invention.

FIG. 3 is a front view of the water meter lock according to the present invention.

FIG. 4 is side view of the water meter lock according to the present invention.

FIG. 5 is a rear view of the water meter lock according-to the present invention.

FIG. 6 is a top view of the water meter lock according to the present invention.

Similar reference characters denote corresponding features consistently throughout the attached drawings.

### DETAILED DESCRIPTION OF THE PREFERRED EMBODIMENTS

The present invention relates to a water meter lock, generally referred to by reference number 10 that accommodates a wide variety of water meters or valves and prevents unauthorized access and tampering of the same. It is noted that although the following makes specific reference to water meters, it should be understood that the water meter lock 10 may also be used in other types of valve and piping configurations, e.g. gas lines.

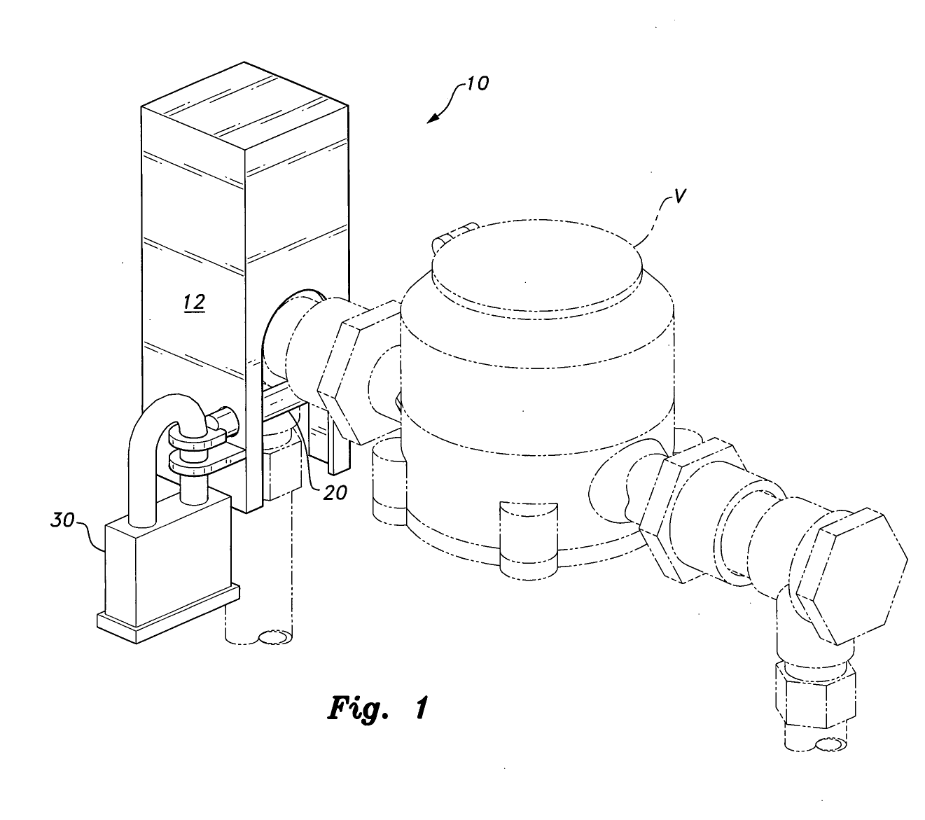

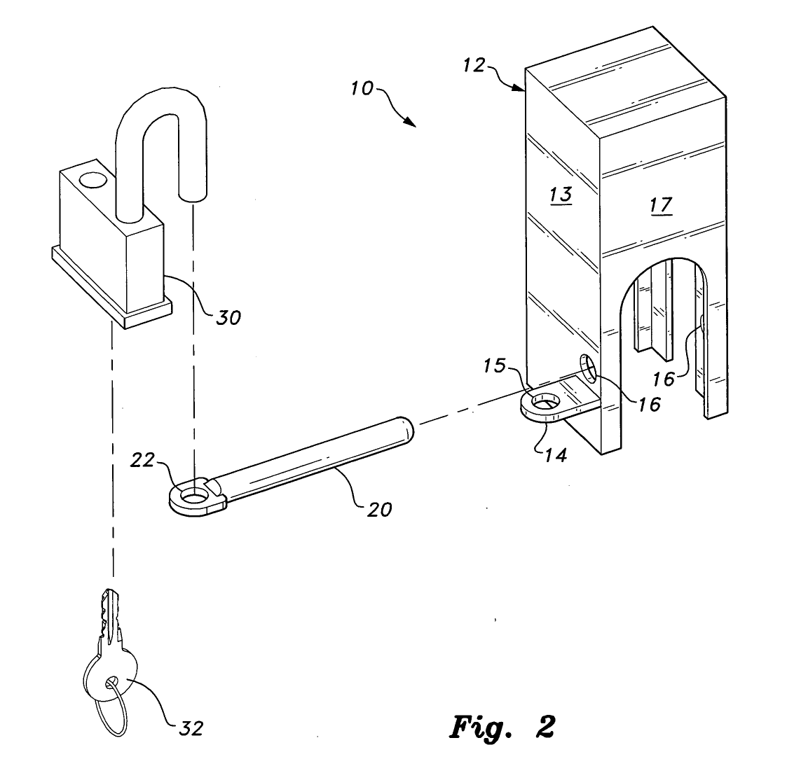

As shown in FIG. 1, the water meter lock 10 includes a housing 12 placed over the valve and piping of a water meter or valve V. The water meter V controls flow of water to the domicile. A locking pin 20 is inserted through appropriate holes in the housing 12 and locked thereto with a padlock 30. In the exemplary embodiment, the housing 12 is a substantially hollow, rectangular box with a closed top and an open bottom. The opposing lateral sides 17 of the housing each include an elongate, arch shaped slot or cutout 18 that extends about half the length of the housing 12, as shown in FIGS. 2 and 4. The cutouts 18 align with each other and permit stable seating of the housing 12 around pipes associated with the valve. The upper portion of the housing 12 provides room to accommodate the actuator of the valve therein. The rear 19 of the housing 12 also includes an elongated, rectangular slot or cutout 11 extending more than half the length of the housing 12. The cutout 11 is adapted to fit over any extensions from the valve, e.g. a locking tab or valve lever. The cutouts 11 and 18 are dimensioned to fit over a wide range of pipes and extensions.

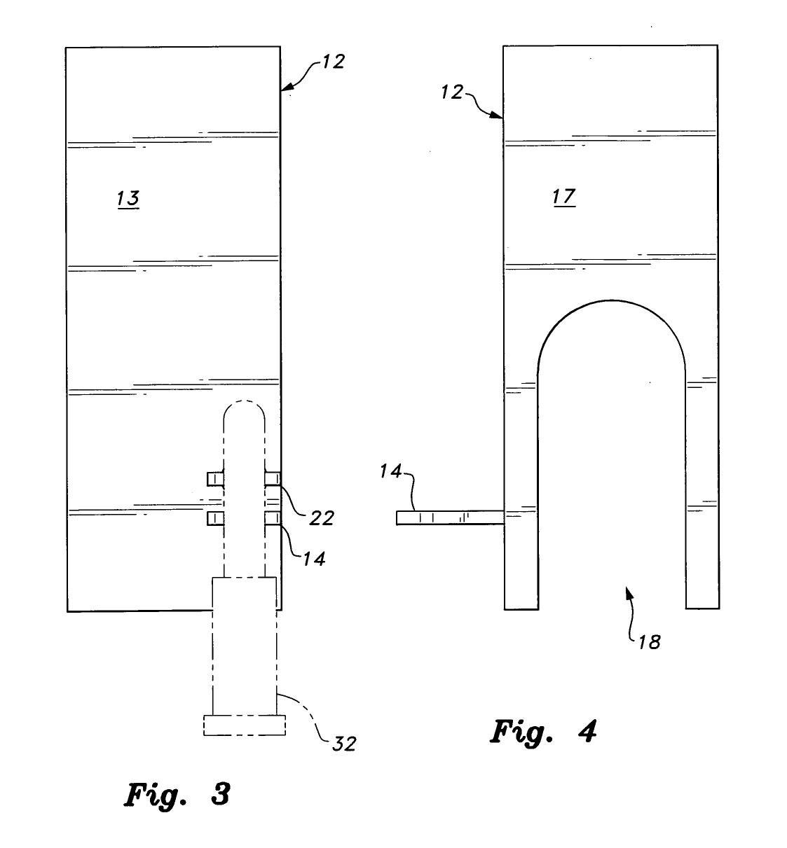

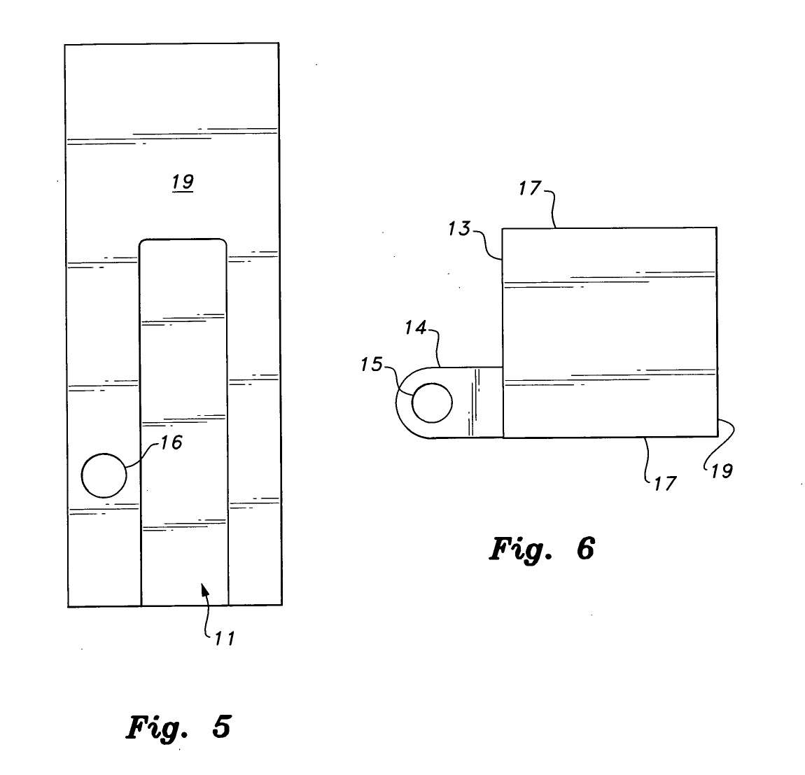

To lock the housing 12 onto the water meter V, the water meter lock 10 includes a locking pin 20. As shown in FIGS. 1-6, both the front 13 and rear 19 of the housing 12 include a through hole or bore 16 disposed adjacent the open end of the housing 12. The holes 16 are aligned with each other, and the locking pin 20 is insertably mounted therethrough. The placement of the holes 16 is such that when the housing 12 is mounted over the valve and pipes, the locking pin 20 passes underneath the pipe to thereby prevent lifting of the mounted housing 12. Once the locking pin 20 is inserted, the locking pin 20 is secured to the housing 12 by a padlock 30 and key 32. To accommodate the padlock 30, the locking pin 20 includes a substantially flat, enlarged head having a through bore or hole 22, and the front 13 of the housing 12 includes a laterally extending locking tab 14 with a corresponding through bore or hole 15, the locking tab 14 being disposed between the hole 16 and bottom of the housing 12. The holes of the locking pin and the locking tab must be aligned so as to allow passage of the padlock hook. The enlarged head limits insertion of the locking pin 20 while the padlock 30 prevents removal of the same. Thus, it can be seen that once the water meter lock 10 is properly mounted and secured, removal of the housing 12 is prevented unless an individual has access to the key 32.

It is noted that the water meter lock 10 encompasses a variety of alternatives. For example, the water meter lock 10 may be made in various shapes, e.g. sphere or cylinder, to more easily accommodate certain valve designs. The water meter lock 10 is preferably made from steel, but other durable materials such as wood, hard plastic or combination thereof may also be used. The water meter lock 10 may also include a variety of distinguishing colors and/or indicia. Moreover, the padlock 30 may be replaced with similar locks that may be threaded through the bores in the locking pin and the locking tab.

It is to be understood that the present invention is not limited to the embodiments described above, but encompasses any and all embodiments within the scope of the following claims.

I claim:

1. A water meter lock, comprising:
a hollow housing adapted to be mounted over a valve, the housing having a closed top, an open bottom, a front wall, a back wall, and lateral sidewalls, the front and the back walls each having a bore defined therein, the bores being aligned, the lateral sidewalls having elongate slots adapted to seat the housing over pipes;
a locking tab laterally extending from the front wall, the locking tab having a locking bore defined therein;
a locking pin insertably mounted through the bores defined in the front and back walls, the locking pin having an enlarged head having a locking bore defined therein; and
a lock threaded through the locking bores to thereby secure the housing around the valve and pipes and prevent removal thereof.

2. The water meter lock according to claim 1, wherein the housing is a substantially elongated rectangular tube.

3. The water meter lock according to claim 1, wherein the housing further comprises an elongate slot formed in the back wall, the elongate slot being adapted to accommodate extensions from the valve.

4. The water meter lock according to claim 3, wherein the length of the back slot is greater than the length of the lateral slots.

5. The water meter lock according to claim 1, wherein the locking pin further comprises an elongated rod having the enlarged head disposed at one end.

6. The water meter lock according to claim 6, wherein the enlarged head is substantially flat, the locking bore being formed therein.

7. The water meter lock according to claim 1, wherein the lock comprises a padlock.
